(19) United States
(12) Patent Application Publication
(10) Pub. No.: US 2024/0327259 A1
(43) Pub. Date: Oct. 3, 2024

(54) Combination of Cationic Polyacrylamide and Xanthan as Flocculation Agents for Harmful Algal Blooms

(71) Applicant: United States of America as Represented by The Secretary of the Army, Alexandria, VA (US)

(72) Inventors: Clinton J Cender, Mahomet, IL (US); Martin A Page, Mahomet, IL (US); Alan J Kennedy, Vicksburg, MS (US)

(21) Appl. No.: 18/130,344

(22) Filed: Apr. 3, 2023

(51) Int. Cl. C02F 1/56; C02F 1/00; C02F 1/40; C02F 1/52

(52) U.S. Cl. CPC C02F 1/56; C02F 1/004; C02F 1/40; C02F 1/5272; C02F 2303/04

(57) ABSTRACT

A water treatment system that includes cationic polyacrylamide (cPAM) and xanthan (i.e., xanthan gum) effectively treats water contaminated with microorganisms such as harmful algal blooms (HAB). The combination of cPAM and xanthan forms cohesive thread-like flocs with the microorganisms entrapped therein. The flocs are then separated from the aqueous media, thereby removing the microorganisms. The combination of cPAM and xanthan has dramatically reduced toxicity compared to cPAM alone.

### GOVERNMENT INTEREST

The subject matter of this disclosure was made with support from the United States Army Corps of Engineers-Engineer Research and Development Center, Construction Engineering Research Laboratory. The Government of the United States of America has certain rights in this invention.

### TECHNICAL FIELD

The present disclosure relates to a water treatment system that includes the combination of cationic polyacrylamide and xanthan and its application for flocculating and removing microorganisms from aqueous media. The disclosure also relates to methods of flocculating and removing microorganisms from aqueous media utilizing the combination of cationic polyacrylamide and xanthan to form cohesive and very stable thread-like flocs entrapping the microorganisms. The present disclosure further relates to systems and methods for treating harmful algal blooms in contaminated water.

### BACKGROUND

Harmful cyanobacteria/algal blooms (HABs) occur when algal species in fresh, brackish, or salt water rapidly grow out of control. HABs often occur as a consequence of introducing excess inorganic substances such as nitrogen and phosphorus into a body of water, leading to the overgrowth of cyanobacteria and blue-green algal species. Another cause of HABs comes from nutrient swelling during extreme weather events or from water stagnation during droughts. Warmer water temperatures, especially above 25° C., also contribute to rapid cyanobacteria growth and HAB formation.

HABs are a worldwide problem due to their massive growth potential and their ability to clog waterways, physically impair aquatic wildlife movement, and inhibit oxygen exchange. Cyanobacteria containing toxins are of particular concern as they have been documented in almost all states and are a high priority concern for inland waterways. Moreover, the issue of HABs is expected to grow as agriculturally induced eutrophication and climate change scenarios predict that in the coming years, waterways will experience heightened conditions that favor cyanobacteria productivity. The ability to mitigate toxic bloom events quickly and without the use of harmful chemicals is a primary goal to ensure the safety of aquatic life and human health and allow authorities to safely manage the HAB biomass.

HABs can adversely impact water chemistry, degrade drinking water supplies, and impact aquatic life through variation in dissolved oxygen content. The public health threat, effects on the fishing industry, and loss of tourism revenue costs billions of dollars every year. As a part of the U.S. Army Corp of Engineers (USACE) mission to provide management and security to the freshwater resources of the United States, the Engineer Research and Development Center (ERDC) has increased stakes in developing technologies for prevention and mitigation of HABs. These freshwater HABs can adversely impact wildlife, drinking water supplies, and dissolved oxygen content. While most algal species are not harmful to human health or the environment, freshwater HABs are usually caused by blue-green algae made up of different types of cyanobacteria that can produce toxins.

Cationic polyacrylamide (cPAM) and other cationic polymers are commonly used in water treatment as a positively charged coagulant in an effort to flocculate and remove colloidal solids in wastewater or natural water sources. cPAM is effective across wide pH and temperature ranges making it useful as a robust treatment for many potential applications. Unfortunately, cPAM has a documented undesirable environmental toxicity with respect to common toxicity testing species such as Ceriodaphnia dubia (water flea) and Pimephales promelas (fathead minnow).

Like many other cationic flocculants, cPAM creates a destabilizing effect on the net charge of the media, which forces anionic suspended particles to flocculate. With respect to cyanobacteria and algae, these flocs or flakes are small and unstable. The resulting flocculated particles need to be concentrated at either the ground or surface of the water to be removed. In many cases, dissolved air flotation (DAF) is used to concentrate the material on the water surface. The unstable nature of the light flakes formed with traditional flocculants are prone to breaking apart with the application of any stress such as the natural or artificial disturbances of the water. The relatively high toxicity, low stability, and low concentration of solids reduce the overall desirability of using cPAM for certain applications.

The concept of rapidly concentrating algal blooms at the air-water interface for improved removal and/or mitigation of HABs has been contemplated. However, previous uses of traditional wastewater treatment flocculants to destabilize the algal dispersion efforts have been largely unsuccessful. A need exists for the development of HAB treatment options that generate stable flocs that withstand turbulence and utilize low or non-toxic materials.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the present disclosure relates to a water treatment system that includes a first composition containing cationic polyacrylamide and a second composition containing xanthan. The system utilizes a combination of the two compositions to remove microorganisms from aqueous media, for example removing cyanobacteria and blue-green algae from HAB contaminated water. According to various embodiments of the system, the combination of cPAM and xanthan, in the presence of microorganisms in an aqueous media, produces cohesive and very stable thread-like flocs that clarify the water, maintain floc structure, and resist many forms of turbulence. According to various embodiments, the water treatment system has a very low toxicity, particularly when compared to the toxicity of cPAM when used alone.

Another aspect of the present disclosure relates to a method for removing microorganisms from aqueous media that includes adding a composition containing cPAM and a composition containing xanthan to an aqueous media containing the microorganisms, in respective amounts sufficient to form cohesive stable thread-like flocs in the aqueous media; forming the thread-like flocs, the flocs containing the cPAM, the xanthan, and the microorganisms entrapped therein; and separating the thread-like flocs from the aqueous media, thereby removing the microorganisms from the aqueous media. According to various embodiments, the method has a very low aquatic toxicity, particularly when compared to the toxicity of cPAM when used alone.

In embodiments of the method for removing microorganisms, the thread-like flocs are formed on the surface of the aqueous media such that they can be removed by skimming from the surface of the aqueous media, or by withdrawing the flocs from the surface by an angled rotating conveyer belt that lifts the flocs out of the aqueous media.

Another aspect of the present disclosure relates to a method of flocculating microorganisms in an aqueous media that includes contacting the microorganisms with cPAM, contacting the microorganisms with xanthan, and flocculating the microorganisms. According to various embodiments, the method has a very low toxicity, particularly when compared to the toxicity of cPAM when used alone.

According to various embodiments, the method of flocculating microorganisms causes the formation of cohesive stable thread-like flocs or fibrillar aggregates that exhibit a high solid to liquid ratio. The physical nature of the thread-like flocs or fibrillar aggregates is different from the floccules obtained through conventional flocculation/coagulation, and the high stability of the aggregates, which hold together under significant agitation, distinguish the present flocs from floccules generated by using current conventionally known polymers and/or chemical coagulants.

Another aspect of the present disclosure relates to a method for treating a HAB in an aqueous body of water that includes adding to the aqueous body of water a water treatment system that includes a first composition containing cationic polyacrylamide and a second composition containing xanthan. According to various embodiments of the method, the combination of cPAM and xanthan, in the presence of HAB microorganisms, produces cohesive and very stable thread-like flocs that clarify the water, maintain floc structure, and resist many forms of turbulence. The thread-like flocs are then separated from the aqueous media, thereby removing the HAB microorganisms. According to various embodiments, the method has a very low aquatic toxicity, particularly when compared to the toxicity of cPAM when used alone.

Other features and advantages of the present disclosure will be apparent from the following description of the drawings, detailed description, and examples, which should not be construed as limiting the disclosure to the examples and embodiments shown and described.

### BRIEF DESCRIPTION OF THE DRAWINGS

FIG. 1 is a flow diagram of a method according to an embodiment of the present disclosure.

FIG. 2 is a photograph of the strong “thread-like” algae flocs formed by treatment with a combination of cPAM and xanthan, according to an embodiment of the present disclosure. The algae flocs readily adsorb air bubbles for ideal flotation and stable suspension against water turbulence.

FIG. 3A and FIG. 3B are graphs showing the identification and percentage of species of algae in the samples (FIG. 3A) and the identification and percentage of species of cyanobacteria cultured from the samples (FIG. 3B) collected from Lake of the Woods (Mahomet, Illinois), used in the Laboratory Trials.

FIG. 4A and FIG. 4B are photographs of a Four-station programmable, backlit Microfloc Platypus Jar Tester (FIG. 4A) and a Microfloc DAF Saturator Assembly (FIG. 4B), used in the Laboratory Trials.

FIG. 5 is a series of photographs showing the ordinal scale (1-5) used to quantitate the qualitative characteristics of observed algae flocculation from methods in accordance with embodiments of the present disclosure. Two observers were used to evaluate and average the data using the ordinal scale to help reduce confirmation bias.

FIG. 6 is a Pareto chart of the effects on flocculation of various materials investigated in the Laboratory Trials. XG—Xanthan Gum; CG—Cationic Guar Gum; TF—TRAMFLOC® 222; PD—polyDADMAC; GF—GREENFLOC® cationic starch; MO-Mineral Oil.

FIG. 7 are photographs of the highly stable putty-like biomass that exhibited syneresis effect and readily sheds water while at rest, according to an embodiment of the present disclosure. The dewatering effect was even more pronounced when non-shear stress was applied. Dewatering is important for the conversion of algal biomass into biodiesel fuel through hydrothermal liquefaction.

FIG. 8 is a graph of toxicology data for aquatic species Ceriodaphnia dubia (water flea) for cPAM (black square) and the combination of cPAM+xanthan gum (XG, 5 mg/L), black triangle).

### DETAILED DESCRIPTION

While the present disclosure will be described in conjunction with specific embodiments, the disclosure can be applied to a wide variety of applications, and the description herein is intended to cover alternatives, modifications, and equivalents within the spirit and scope of the disclosure and the claims. The description in the present disclosure should not be viewed as limiting or as setting forth the only embodiments of the disclosure, as the disclosure encompasses other embodiments not specifically recited herein. The present disclosure is directed toward all novel and non-obvious features and aspects of the various disclosed embodiments. Any theories of operation are to facilitate explanation, but the disclosed methods and devices are not limited to such theories of operation.

The present disclosure relates to the removal of microorganisms, such as algae and cyanobacteria, from aqueous media by treatment of the aqueous media with cPAM and xanthan. As used herein, “aqueous media” and “water” are interchangeable. Aqueous media includes a stream, a creek, a river, a pond, a reservoir, wetlands, irrigation water, wastewater, a source of drinking water, a pool, a lake, a lagoon, a bay, a sea, an ocean, or the like. Aqueous media includes polluted water, water contaminated with microorganisms, and water contaminated with a HAB. Aqueous media includes freshwater, saltwater, or brackish water.

The present disclosure relates to a water treatment system that includes a first composition containing cPAM and a second composition containing xanthan. According to various embodiments, the combination of cPAM and xanthan produces very stable and cohesive thread-like flocs that entrap microorganisms present in the water. The cohesive flocs maintain their thread-like structure and are very resistant to all forms of turbulence, such as waves, boat wakes, and wind currents.

Research into the natural flotation methods of cyanobacteria led the present inventors to the use of the polysaccharide xanthan to simulate the extracellular polymeric substances (EPS) secreted naturally by the cyanobacteria to capture air for upward mobility. Introducing xanthan to the colloidal system provided an artificial abundance of EPS that bind cyanobacteria and algae together. In various embodiments, the cPAM forms a complex with the xanthan infused cyanobacteria and algae (“hyper-bridging”) to form thick mucus-like strands, referred to herein as cohesive stable thread-like flocs or fibrillar aggregate, that are extremely concentrated and stable, and readily trap air during flotation.

According to various embodiments of the system, the addition of xanthan also reduces the toxic impact of the cPAM by several fold, such as by about 5-10 fold, about 10-20 fold, about 20-30 fold, about 30-50 fold, or about 50-100 fold, or more, on Ceriodaphnia dubia in laboratory toxicity studies. Without this unique hyper-bridging effect, cPAM is both too toxic to use in significant quantities and ineffective at producing a stable high concentration of algae or other microorganisms or suspended solids for further processing.

According to various embodiments, toxicity is measured according to well established United States Environmental Protection Agency (EPA) protocols and standards. The following references are incorporated herein in their entirety: EPA-821-R-02-012 (Methods for Measuring the Acute Toxicity of Effluents and Receiving Waters to Freshwater and Marine Organisms, Fifth Edition, October 2002); EPA-821-R-02-013 (Short-term Methods for Estimating the Chronic Toxicity of Effluents and Receiving Waters to Freshwater Organisms, Fourth Edition, October 2002); OECD/OCDE 202 (OECD Guidelines for Testing of Chemicals, Daphnia sp., Acute Immobilisation Test, Adopted April 2004); OECD/OCDE 203 (OECD Guidelines for the Testing of Chemicals, Fish Acute Toxicity Test, Adopted June 2019).

According to various embodiments of the system, the combination of cPAM and xanthan provides rapid coagulation kinetics in the form of hyper-bridging of cohesive stable thread-like flocs or fibrillar aggregate. In various embodiments, the combination of flocculated cPAM, xanthan, and microorganisms forms a biomass having a significant degree of water shedding with the application of low stress, leading to high dewatering efficacy in post-processing the biomass. According to various embodiments, the cPAM, xanthan, and microorganisms combine to form a biomass that exhibits significant syneresis when at rest and naturally sheds water to about 7-10% solids by weight before any post processing. In some embodiments, after post processing, the biomass material reaches about 16-17% solids by weight with minimal manual effort.

According to various embodiments, the first composition is in the form of a dry powder or solid, as an emulsion, or as an aqueous solution containing cPAM dissolved therein. In embodiments of the aqueous solution, the concentration of cPAM is not particularly limited, and any readily or commercially obtainable concentration is used. In some embodiments, the concentration is generally defined by the solubility of the cPAM in the solvent carrier solution (i.e., water). In some embodiments, a “stock” solution has a cPAM concentration of about 0.1%-1.0% w/v, or about 0.2%-0.5% w/v. In some embodiments, the first composition is a stock emulsion containing cPAM at a concentration in a range of about 1% to 10% w/v. In some embodiments, the first composition is an aqueous solution containing cPAM at a concentration in a range of about 0.1%-1.0% w/v.

According to various embodiments, the first composition contains cPAM as a dry powder, a granulate, or solid tablet form. In embodiments, the cPAM is a commercially available stock composition, such as, for example, various TRAMFLOC® cationic flocculants (Tramfloc, Inc., Spring, Texas). Embodiments of the composition also contain binder and/or release agent. The molecular weight (MW) of commercial cPAM generally ranges from about 105 to greater than 107 Da. In some embodiments, the cPAM is high MW, having a MW greater than 106 Da or greater than 107 Da.

The term “polyacrylamide” is used herein to describe any polymer with acrylamide present as one of the monomers. More rigorously, its IUPAC nomenclature is poly(prop-2-enamide). According to various embodiments, polyacrylamide is a water-soluble polymer formed by the polymerization of either acrylamide monomers or N,N′-methylenebis(acrylamide). Polyacrylamide with only acrylamide monomers is nonionic, having the structure

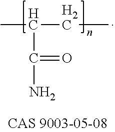

In various embodiments, other monomers such as dimethyldiallylammonium and ethanaminium (N,N,N-trimethyl-2-((1-oxo-2-propenyl)oxy) are co-polymerized at various percentages to form cationic polyacrylamides, for example having the structures:

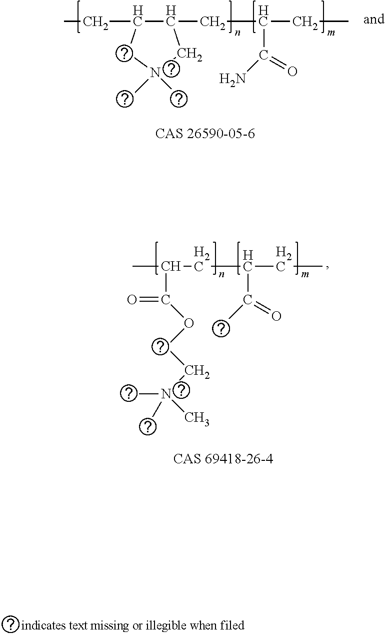

respectively.

According to various embodiments, cPAM includes, but it not limited to, acrylamide copolymers of diallydimethylanimonium chloride (DADMAC; CAS 26092-79-3), dimethylaminoethylacrylate (DMAEA; CAS 2439-35-2), dimethylaminoethylmethacrylate (DMAEM; CAS 2867-47-2), and 3-methylamidepropyltrimethylammonium chloride (MAPTAC; CAS 51410-72-1).

According to various embodiments, “xanthan” or “xanthan gum” or “xanthan polymer” as used herein refers to a high molecular weight polyanionic polysaccharide produced by a bacterium, such as Xanthomonas campestris, Xanthomonas phaseoli, or Xanthomonas juglandis, having the structure

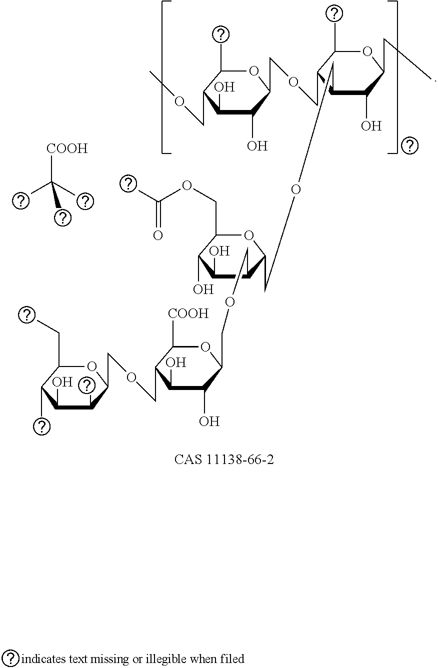

In various embodiments, xanthan is in the form of a dry powder, granulate, or solid tablet, or in solution as a xanthan gum.

According to various embodiments of the system, the first composition consists of or consists essentially of cPAM. In some embodiments, the first composition contains a mixture of cPAM and one or more additional cationic polymer and/or one or more nonionic polymer. According to various embodiments of the system, the second composition consists of or consists essentially of xanthan. In some embodiments, the second composition contains a mixture of xanthan and one or more additional anionic polymer and/or one or more nonionic polymer. Embodiments of the system also include a composition that contains a combination of cPAM and xanthan.

According to various embodiments, the water treatment system further includes microorganisms flocculated from an aqueous media. Various embodiments of the system include microorganisms such as virus, bacteria, archaca, fungus, yeast, mold, algae, protozoa, and parasites. In various embodiments, the microorganism is one or more type of cyanobacteria, blue-green algae, golden algae, phytoplankton, benthic algae, or macroalgae. In various embodiments, the algae and/or cyanobacteria is from water contaminated by a HAB. In some embodiments, the microorganism is cyanobacteria, such as one or more of genera Microcystis, Anabaena, Dolichospernum, Synechocystis, Fischerella, Gloeotrichia, Nodularia, Nostoc, Oscillatoria, Planktothrix, Raphidiopsis, Cylindrospermopsis, Aphanizomenon, Umezakia, Lyngbya, Chrysosporum, Cuspidothrix, Cylindrospermum, Phormidium, Tychonema, and Woronichinia.

According to various embodiments of the water treatment system, the cPAM, xanthan, and microorganisms combine to form a biomass having a high solid to liquid ratio that is easily dewatered. Various embodiments of the system provide a biomass having a solids content of at least 7% or greater, or about 7-10%, by weight.

According to various embodiments of the water treatment system, the first composition containing cPAM and the second composition containing xanthan are provided in the form of a kit.

The present disclosure also relates to a method for removing microorganisms from aqueous media. The method includes adding a composition containing cPAM and a composition containing xanthan to the aqueous media. In some embodiments, the cPAM and xanthan are added sequentially, and in some embodiments, the cPAM and xanthan are added simultaneously. The sequential order is not limited, and in some embodiments, the xanthan is added first followed by the cPAM, while in other embodiments, the cPAM is added first followed by the xantham. Embodiments also include adding both the xanthan and cPAM simultaneously or adding a composition containing a combination of xanthan and cPAM.

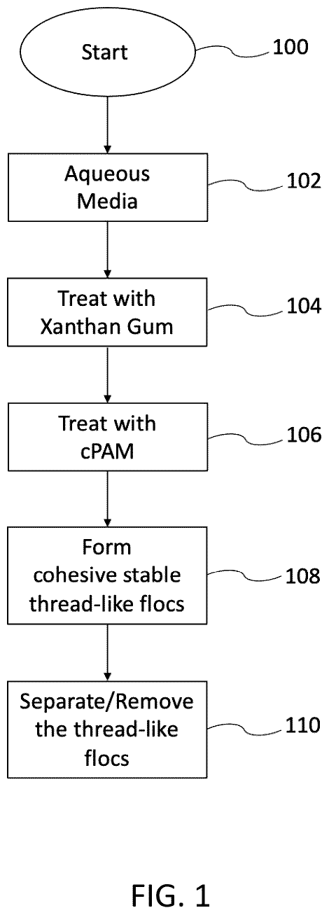

Referring to FIG. 1, a method is disclosed for treating an aqueous media having microorganisms desired to be removed from the media. The method starts in block 100. From block 100, the method enters block 102. Block 102 is to identify the aqueous media that has microorganisms to be removed. In various embodiments, the aqueous media includes, but is not limited to, any water, such as freshwater, brackish water, or saltwater from any source, such as, but not limited to a stream, a creek, a river, a pond, a reservoir, wetlands, irrigation water, waste water, a source of drinking water, a pool, a lake, a lagoon, a bay, a sea, an ocean, and the like.

In block 104, the aqueous media is treated with the xanthan. In some embodiments, the xanthan is added before the cPAM; however, in other embodiments, the xanthan and cPAM are added simultaneously, and in other embodiments the cPAM is added before the xantham. According to various embodiments, the xanthan is added to the aqueous media as a dry powder, granules, tablets, or some combination thereof, or is added as a solution. After addition of the xanthan, in some embodiments the water is mixed or agitated to distribute the xanthan in the aqueous media.

The effective amount of xanthan to add for the removal of the microorganisms from the aqueous media can be determined by conducting trials on the water and noticing when the desired effect is achieved. The effective amount of xanthan is also dependent on the amount or concentration of the microorganism(s) that is in the aqueous media being treated. The effective amount of xanthan is that amount that, when combined with an amount of cPAM, produces cohesive stable thread-like flocs that entrap the microorganisms. In various embodiments, a range of about 0.01 ppm by weight to about 1000 ppm by weight for each of xantham and cPAM and a ratio of xanthan to cPAM of 1:1 to 1:1000 are possible depending on the microorganism and concentration. In some embodiments, the concentration of xanthan is in a range of about 0.1 mg/L to 100 mg/L, about 0.5 mg/L to 20 mg/L, or about 1 to 10 mg/L. In various embodiments, the concentration of cPAM is approximately the same, less than, or more than the concentration of xanthan.

In block 106, the aqueous media is treated with the cPAM. In some embodiments, the xanthan is added before the cPAM; however, in other embodiments, the xanthan and cPAM are added simultaneously, and in other embodiments the cPAM is added before the xantham. According to various embodiments, the cPAM is added to the aqueous media as a dry powder, granules, tablets, or some combination thereof, or is added as a solution. After addition of the cPAM, in some embodiments the water is mixed or agitated to distribute the cPAM in the aqueous media.

The effective amount of cPAM to add for the removal of the microorganisms from the aqueous media can be determined by conducting trials on the water and noticing when the desired effect is achieved. The effective amount of cPAM is also dependent on the amount or concentration of the microorganism(s) that is in the aqueous media being treated. The effective amount of cPAM is that amount that, when combined with an amount of xanthan, produces cohesive stable thread-like flocs that entrap the microorganisms. In various embodiments, a range of about 0.01 ppm by weight to about 1000 ppm by weight for each of cPAM and xanthan and a ratio of cPAM to xanthan of 1:1 to 1:1000 are possible depending on the microorganism and concentration. In some embodiments, the concentration of cPAM is in a range of about 0.1 mg/L to 100 mg/L, about 0.5 mg/L to 20 mg/L, or about 1 to 10 mg/L. In various embodiments, the concentration of xanthan is approximately the same, less than, or more than the concentration of cPAM.

In some embodiments, the concentration of xanthan and cPAM depends on the algae species and density. In some embodiments, about 3 mg/L of cPAM and about 5 mg/L of xanthan is an effective dose. At amounts lower than 1 mg/L, cPAM may begin to lose effectiveness, and while amounts of 10 mg/L or higher remain effective, there may be diminishing returns on algae removal. Similarly, xanthan is effective at 2 mg/L or higher, but at higher than 10 mg/L there may be diminishing returns on algae removal, and it could significantly thicken the source water as the xanthan molecules swell.

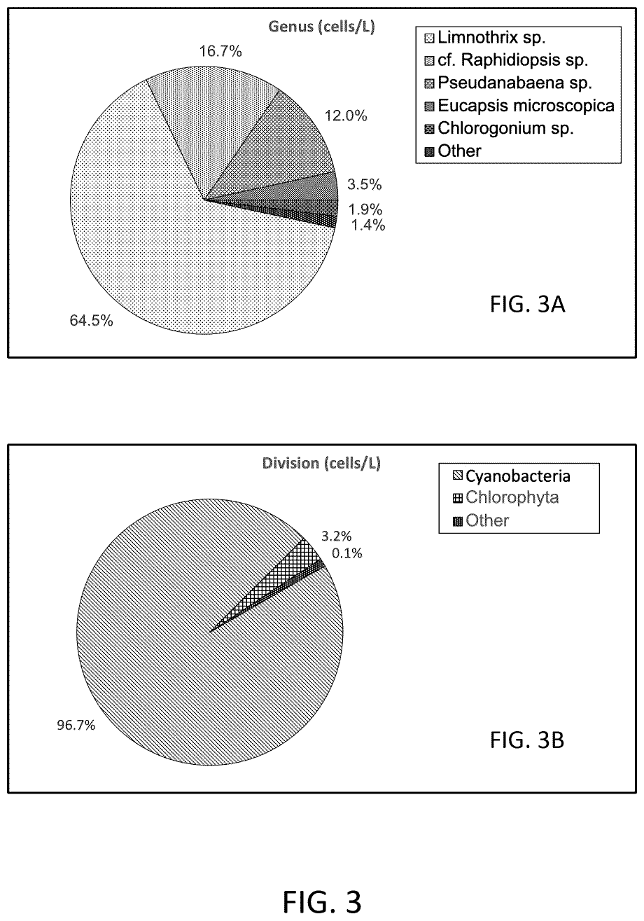

In block 108, a product of treating water containing microorganisms with xanthan and cPAM is cohesive, stable, thread-like flocs. The flocs include a plurality of fibers and fibrils that surround and hold and entrap the microorganisms. The thread-like flocs include the cPAM, the xanthan, and the microorganisms entrapped therein (initially present in the water in block 102). The cohesive stable thread-like flocs produced according to the disclosed methods are unlike floccules in that the flocs are much more cohesive and resistant to dispersion and have a higher tensile strength binding the fibers and fibrils and microorganisms together. As shown in FIG. 3, an embodiment of the method for treating water containing cyanobacteria forms cohesive stable thread-like algae flocs. Furthermore, the algae flocs readily adsorb air bubbles for ideal flotation and stable suspension against water turbulence.

In block 110, the cohesive stable thread-like flocs formed in block 108 are collected and/or removed from the aqueous media. The flocs include the cPAM, the xanthan, and the microorganisms initially present in the aqueous media in step 102. An advantage to creating the cohesive stable flocs containing the cPAM and xanthan is that it allows the aqueous media to be filtered or sieved through a coarse filter or screen. The floc is trapped on the screen and the aqueous media passes through the filter or screen, after which the aqueous media contains a reduced amount of the microorganism(s). Because of the highly cohesive and stable nature of the floc that are formed by the disclosed method, a high flow rate of filtration can be achieved.

An advantage of the methods for removing microorganisms using a combination of cPAM and xanthan as disclosed herein is the reduced toxic impact of the cPAM compared to that of cPAM when used alone. Embodiments of the method reduce the toxicity of cPAM, measured according to protocols and standards established by the EPA, by about 5-10 fold, about 10-20 fold, or about 50-100 fold, or more. Without the addition of xanthan, cPAM is too toxic to use in significant quantities.

Another advantage of the cohesive stable thread-like flocs produced according to the disclosed methods is their high solid to liquid ratio. Various embodiments of the disclosed methods further include forming a biomass from the separated thread-like flocs and dewatering the biomass. A biomass of floc material produced according to embodiments of the disclosed methods is easily dewatered to a solids content of at least 7% or greater by weight. Various embodiments include further processing the biomass to a solids content of at least 16% or greater by weight.

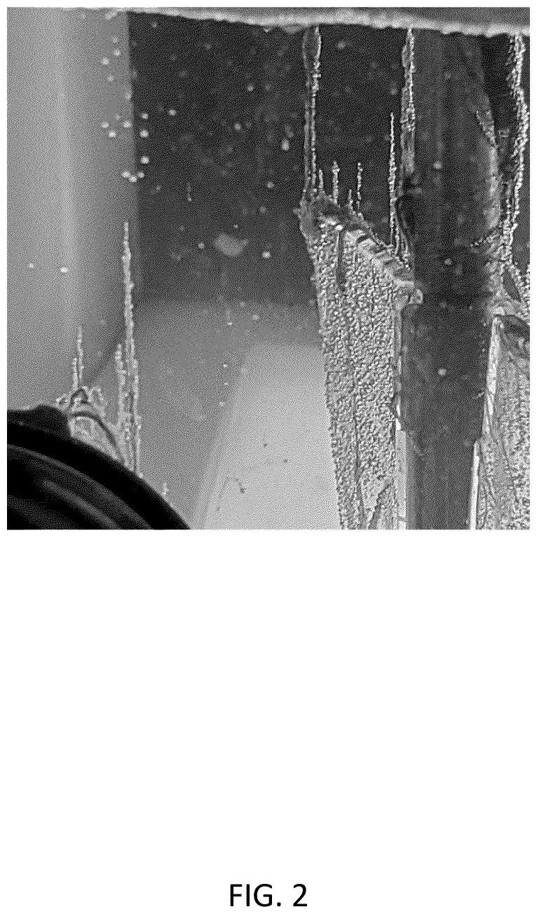

According to various embodiments of the method, the cohesive stable thread-like flocs are formed on the surface of the aqueous media. As shown in FIG. 2, the thread-like flocs readily adsorb air bubbles and are ideal for flotation and stable suspension against water turbulence. In various embodiments, the flocs are separated from the aqueous media by skimming the surface of the aqueous media or by withdrawing the flocs from the surface with an angled rotating conveyer belt that lifts the flocs out of the aqueous media. According to various embodiments, the method further includes flowing the aqueous media through a screen, mesh, or porous filter to separate the thread-like flocs from the aqueous media.

The present disclosure also relates to a method of flocculating microorganisms in an aqueous media by treating the media with a combination of cPAM and xanthan. According to various embodiments, the method includes contacting the microorganisms with cPAM, contacting the microorganisms with xanthan, and flocculating the microorganisms.

According to various embodiments, the microorganisms include one or more of virus, bacteria, archaca, fungus, yeast, mold, algae, protozoa, and parasites. In various embodiments, the microorganism is one or more type of cyanobacteria, blue-green algae, golden algae, phytoplankton, benthic algae, or macroalgae. In various embodiments, the algae and/or cyanobacteria is from water contaminated by a HAB. In some embodiments, the microorganism is cyanobacteria, such as one or more of genera Microcystis, Anabaena, Dolichospernum, Synechocystis, Fischerella, Gloeotrichia, Nodularia, Nostoc, Oscillatoria, Planktothrix, Raphidiopsis, Cylindrospermopsis, Aphanizomenon, Umezakia, Lyngbya, Chrysosporum, Cuspidothrix, Cylindrospermum, Phormidium, Tychonema, and Woronichinia.

According to various embodiments of the method of flocculating microorganisms, the xanthan is present in the aqueous media in an amount sufficient to bind the microorganisms together, and the cPAM is present in the aqueous media in an amount sufficient to complex with the xanthan gum and microorganisms to form cohesive stable thread-like flocs. In embodiments, the cPAM, xanthan, and microorganisms form cohesive stable thread-like flocs in the aqueous media.

According to various embodiments of the method, the concentration of xanthan in the aqueous media is in a range of about 0.01 ppm to about 1000 ppm by weight, or about 0.01-1 ppm, about 0.1-10 ppm, about 1-100 ppm, or about 10-1000 ppm, by weight. In some embodiments, the concentration of xanthan is in a range of about 0.1-100 mg/L, about 0.5-20 mg/L, or about 1-10 mg/L According to various embodiments, the concentration of cPAM in the aqueous media is in a range of about 0.01 ppm to about 1000 ppm by weight, or about 0.01-1 ppm, about 0.1-10 ppm, about 1-100 ppm, or about 10-1000 ppm, by weight. In some embodiments, the concentration of cPAM is in a range of about 0.1-100 mg/L, about 0.5-20 mg/L, or about 1-10 mg/L.

According to various embodiments, the method includes first contacting the microorganisms with the xanthan to infuse the microorganisms and bind the microorganisms together, and then contacting the xanthan infused and bound microorganisms with the cPAM. In other embodiments, the method includes contacting the microorganisms simultaneously with the cPAM and xanthan.

The present disclosure also relates to a method for treating HABs in an aqueous media that includes treating the aqueous media with an embodiment of the water treatment system as disclosed herein. According to various embodiments, methods for treating a HAB include utilizing a water treatment system that includes a first composition containing cPAM and a second composition containing xanthan. In various embodiments, the first composition containing cPAM and the second composition containing xanthan are added to the aqueous media in respective amounts sufficient to form cohesive stable thread-like flocs. The cohesive flocs are formed from cPAM, xantham, and the HAB microorganisms entrapped therein. The combination of cPAM and xanthan produces very stable and cohesive thread-like flocs that entrap the HAB microorganisms present in the aqueous media. The cohesive flocs maintain their thread-like structure and are very resistant to all forms of turbulence. In various embodiments, the thread-like flocs are then separated from the aqueous media, thereby removing the HAB microorganisms from the aqueous media.

According to various embodiments, the HAB microorganisms include one or more type of cyanobacteria, blue-green algae, golden algae, phytoplankton, benthic algae, or macroalgae. In some embodiments, the microorganism is cyanobacteria, such as one or more of genera Microcystis, Anabaena, Dolichospernum, Synechocystis, Fischerella, Gloeotrichia, Nodularia, Nostoc, Oscillatoria, Planktothrix, Raphidiopsis, Cylindrospermopsis, Aphanizomenon, Umezakia, Lyngbya, Chrysosporum, Cuspidothrix, Cylindrospermum, Phormidium, Tychonema, and Woronichinia.

According to various embodiments for treating HABs in an aqueous media, the xanthan is present in the aqueous media in an amount sufficient to bind the HAB microorganisms together, and the cPAM is present in the aqueous media in an amount sufficient to complex with the xanthan gum and HAB microorganisms to form cohesive stable thread-like flocs. In embodiments, the cPAM, xanthan, and HAB microorganisms form cohesive stable thread-like flocs in the aqueous media. According to various embodiments of the method, the concentration of xanthan in the aqueous media is in a range of about 0.01 ppm to about 1000 ppm by weight, or about 0.01-1 ppm, about 0.1-10 ppm, about 1-100 ppm, or about 10-1000 ppm, by weight. In some embodiments, the concentration of xanthan is in a range of about 0.1-100 mg/L, about 0.5-20 mg/L, or about 1-10 mg/L. According to various embodiments, the concentration of cPAM in the aqueous media is in a range of about 0.01 ppm to about 1000 ppm by weight, or about 0.01-1 ppm, about 0.1-10 ppm, about 1-100 ppm, or about 10-1000 ppm, by weight In some embodiments, the concentration of cPAM is in a range of about 0.1-100 mg/L, about 0.5-20 mg/L, or about 1-10 mg/L.

According to various embodiments, the method includes first adding the xanthan to the aqueous media and then adding the cPAM to the aqueous media. In other embodiments, the xanthan and cPAM are added simultaneously to the aqueous media.

An advantage to the methods for treating HABs using a combination of cPAM and xanthan as disclosed herein is the reduced toxic impact of the cPAM compared to that of cPAM when used alone. Embodiments of the method reduce the toxicity of cPAM, measured according to protocols and standards established by the EPA, by about 5-10 fold, about 10-20 fold, or about 50-100 fold, or more. Without the addition of xanthan, cPAM is too toxic to use in significant quantities.

### EXAMPLES

Algae Cultures. Mixed species cyanobacteria samples were collected and cultured from Lake of the Woods in Mahomet, Illinois. The samples were cultured under controlled laboratory conditions and maintained for experimentation. The algae cultures were identified externally by BSA Environmental Services Inc. (Beachwood, Ohio). The samples contained primarily the cyanobacteria Limnothrix sp. (FIG. 3A), and the vast majority of the culture contained cyanobacteria over any other type of organism (FIG. 3B).

Jar Testing. Jar tests were performed to evaluate the ability of compounds and compound combinations to form aggregates of algal colonies that are subject to separation by Dissolved Air Flotation (DAF). Four laboratory trials were conducted.

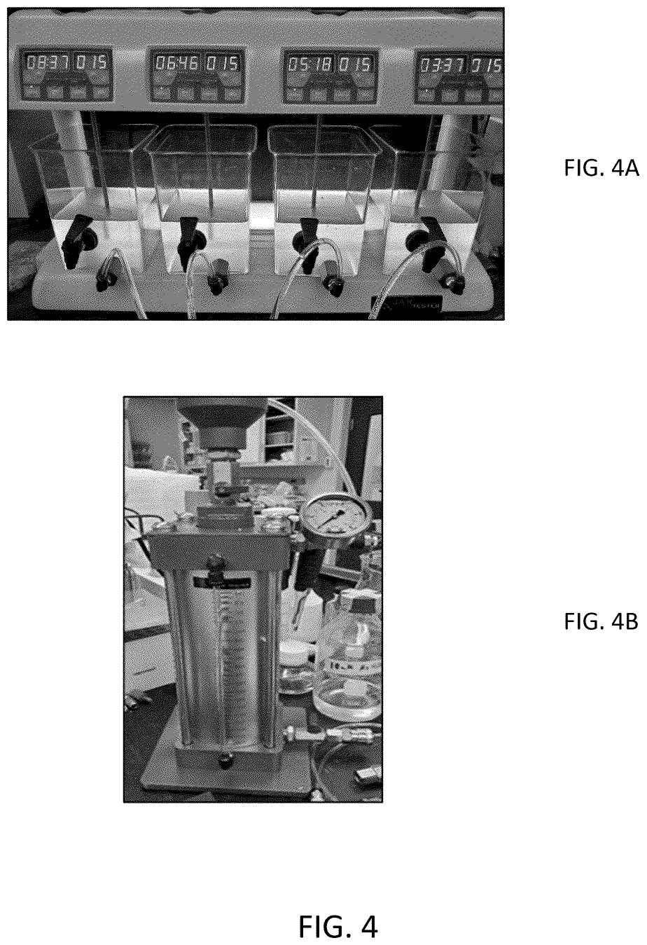

All experimental treatments were performed using a four station, programmable, and backlit Microfloc Platypus Jar Tester (FIG. 4A). Each jar was filled to one liter of algae laden water for the experimental trials. The agitation program was set to three constant intervals: 30 s at 75 RPM, 120 s at 35 RPM, and 5 s at 15 RPM. Additives were consistently dosed at the start of the first interval in the program. All cationic additives were dosed after anionic or non-ionic additives were dosed. Measurements were collected 120 s after addition of dissolved air from the DAF unit when visibility returned.

DAF microbubbles were supplied by a Microfloc DAF Saturator Assembly including a four-port distribution manifold (FIG. 4B). Microbubbles were introduced in the lower quarter of the jars immediately following the completion of the mixing procedures. In each experimental treatment, microbubbles were supplied individually to prevent reduced air pressure across the manifold.

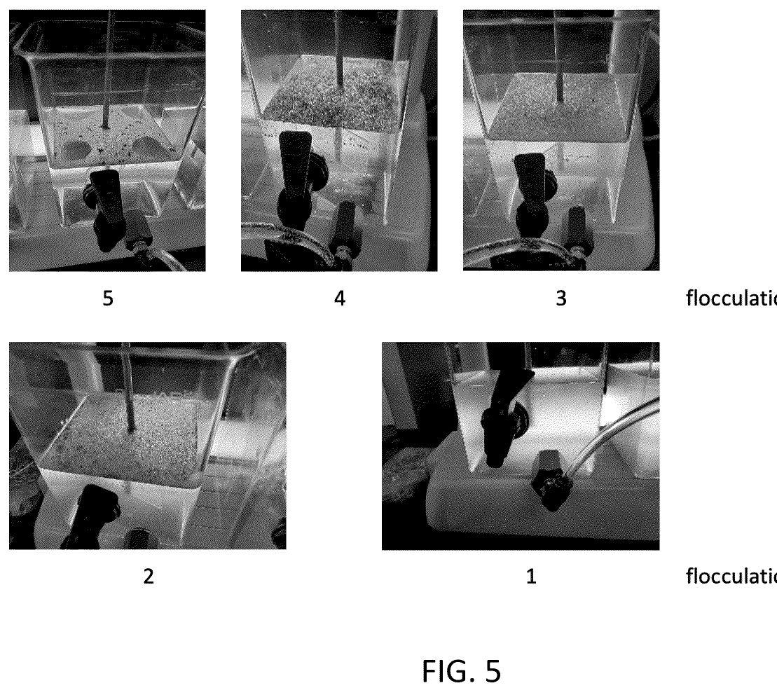

Quantitative Methods. During laboratory trials, the effects of the tested materials on floc formation and water clarification were initially difficult to quantify. Turbidity was investigated but ultimately was unable to correlate to the observed effects. Thus, an ordinal scale of 1-5 was developed, based on a control and ideal flocculation effects, where 0 represented no or a very minimal effect and 5 represented a significant effect. (Table 1). FIG. 5 provides photographs showing the degree of flocculation and the ordinal scale.

TABLE 1
Flocculation Ordinal Scale

| Flocculation | |
|---|---|
| Ordinal Scale | Description |
| 5 | Significant water clarity. Algae flocs are extremely |
| | dense and filamentous. Flocs are unable to be redispersed |
| | into the water through agitation. |
| 4 | Significant water clarity. Algae flocs are tighter |
| | but not dense. Few flocs can be redispersed through |
| | agitation. |
| 3 | Some clarity of water but noticeably green/opaque. |
| | Algae flocs are visible and somewhat loose. Flocs can |
| | be redispersed through agitation. |
| 2 | Water clarity is poor. Few algae flocs are visible |
| | and easily redispersed through agitation. |
| 1 | Water is green and considerably opaque. Nearly no |
| | algae flocs visible. Algae already dispersed in |
| | the water. |

The ordinal scale was used to bridge a gap between obvious qualitative characteristics and the need for quantifiable data to drive statistical analysis and optimization. Two observers, Operator 1 and Operator 2, were used to evaluate and average the data using the ordinal scale to help reduce confirmation bias. The results were a semi-quantifiable ordinal scale with reduced confirmation bias. These data were then analyzed using traditional statistics to determine the first and second order effects for optimization.

Laboratory Trials. Laboratory trials evaluated the performance of compounds and compound combinations in the floatation and flocculation of algal colonies in water.

TABLE 2
Factors that remained constant in each laboratory trial.
Constants

| | |
|---|---|
| Mixing interval 1 | 30 s at 75 rpm |
| Mixing interval 2 | 120 s at 35 rpm |
| Mixing interval 3 | 5 s at 15 rpm |
| Measurement interval | 120 s after DAF |
| Algae source | Shadow Lake, Mahomet |
| Algae species | Mixed; uncontrolled |
| Additive lot numbers | Constant for each material |
| DAF bubble size distribution | Greater than 1 micron |

Laboratory Trial #1 was a preliminary assessment in which gum arabic (GA) was tested on algal cultures at concentrations between 10 mg/L and 5,000 mg/L. The cationic polyacrylamide copolymer TRAMFLOC® 300 (TF300) was also evaluated on algal cultures at 10 mg/L. GA and TF300 were also tested in combination at an application ratio of 1:2 under ambient conditions and no pH adjustment. One hundred milliliters of DAF saturated air were added to induce algae flotation/separation. The observations from Trial #1 were evaluated for turbidity, which was determined to be less than informative for quantitative data collection. Consequently, an ordinal scale was developed and used to quantify the qualitative characteristics of observed algae flocculation.

Laboratory Trial #2 evaluated treatment combinations of cPAM (TF222) and xanthan gum (XG) applied to an algae culture at a ratio of 2:0 under static conditions and ambient temperature (23° C.) at pH 7. One hundred milliliters of DAF saturated air were added to the reactors. In a second test batch, cationic guar gum (CGG) and xanthan gum (XG) were also tested in combination in the algae culture at a ratio of 2:2 with 200 mL of DAF saturated air applied. Culture temperature was increased to 35° C., and pH was adjusted to 10. (Table 3).

TABLE 3
Experimental arrangement for Lab Trial #2

| Level Settings | −1 | 1 |
|---|---|---|
| Block (B) | | |
| −> pH | 7 | 10 |
| −> Temp (T) (° C.) | 23 (ambient) | 35 |
| −> Turbulence, additional (TF) | N | Y |
| Additive ratio (AR) | TF222:XG | CGG:XG |
| Additive concentration (AC) (mg/L) | 2:0 | 2:2 |
| DAF volume (DV) (mL) | 100 | 200 |

The observations from Trial #2 indicated that there was signification synergy between cPAM (TF222) and xanthan gum (XG) in flocculation efficacy on the algae cultures.

Laboratory Trial #3 screened multiple potential coagulants to examine them for flocculation efficacy. Each coagulant was tested in combination with each other using an orthogonal matrix, and quantified using the developed ordinal scale, to quantify the observed effects. Trial #3 evaluated cationic guar gum (CGG), xanthan gum (XG), TRAMFLOC® 222 (TF), Polydiallyldimethylammonium chloride (PD), GREENFLOC® cationic starch GFT5100 (GF), and mineral oil (MO) on algae cultures at concentrations of 0.5 mg/L, 0.3 mg/L, 0.5 mg/L, 0.1 mg/L, 0.5 mg/L, and 1.0 mg/L, respectively. Algae cultures were adjusted to pH 10 and subjected to 100 mL of DAF saturated air.

TABLE 4
Experimental arrangement for Lab Trial #3

| Level | | | |
|---|---|---|---|
| Settings | −1 | 1 | Units |
| pH | 8 | 10 | |
| XG | 0 | 0.3 | mg/L |
| CGG | 0 | 0.5 | mg/L |
| TF | 0 | 0.5 | mg/L |
| PD | 0 | 0.1 | mg/L |
| GF | 0 | 0.5 | mg/L |
| MO | 0 | 1 | mg/L |

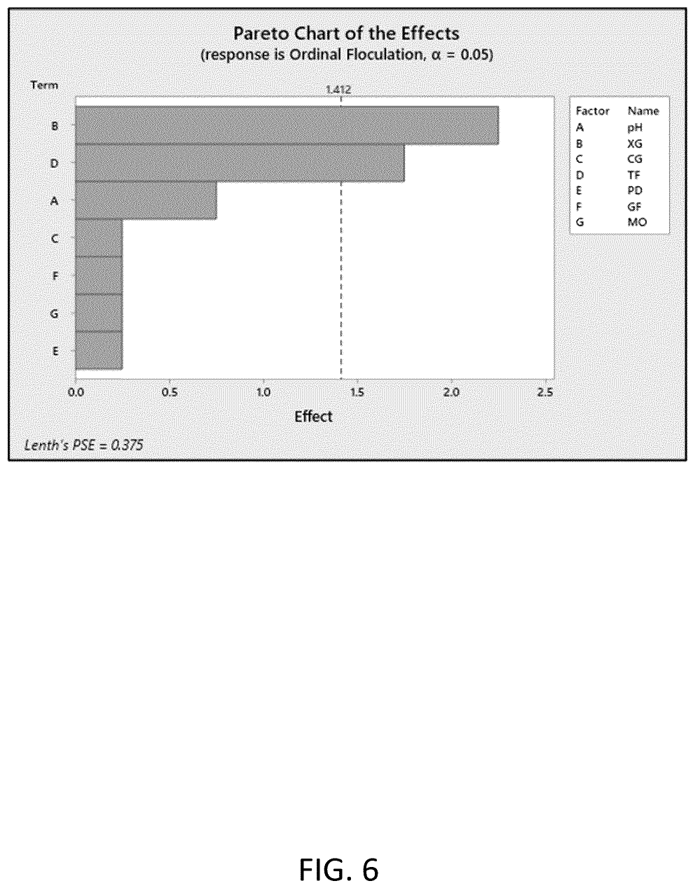

Shown in FIG. 6 is a Pareto chart of the effects on flocculation in Trial #3. Only the combination of cPAM (TF) and xanthan gum (XG) were significantly effective at producing high stability coagulated biomass.

Laboratory Trial #4 tested TF 222 (TF), BHR-P50 hybrid flocculant (BHR), and inorganic poly-aluminum chloride (PAC 1400 and PAC 1430), along with three polysaccharide gum types including xanthan gum (XG), diutan gum (DG), and gellan gum (GG), to evaluate the formation of stable coagulated biomass. One hundred milliliters of DAF saturated air were applied to each test solution. The inorganic PAC coagulants showed essentially no positive interaction effects with any of the polysaccharide gums.

TABLE 5
Experimental arrangement for Lab Trial #4

| | −1 | 0 | 1 | |
|---|---|---|---|---|
| | Level Settings | | | |
| | Xanthan | Diutan | Gellan | |
| Gum | gum (XG) | gum (DG) | gum (GG) | units |
| TF | 0 | 0.25 | 0.5 | mg/L |
| BHR | 0 | 200 | 400 | mg/L |
| PAC1400 | 0 | 100 | 200 | mg/L |
| PAC1430 | 0 | 100 | 200 | mg/L |

Dewatering Analysis. Based on the structure of the xanthan gum and the stability of the biomass, the inventors hypothesized that the material would prove to be much easier to dewater. Dewatering the biomass is a critical step in the hydrothermal liquefaction conversion of biomass to biofuel. A target % solids contents is 18-20%. Previous treatments had achieved 2-4% solids and a final result of 6-7% after post processing. Further study and pilot scale (500 gallon/min) trials proved this hypothesis true.

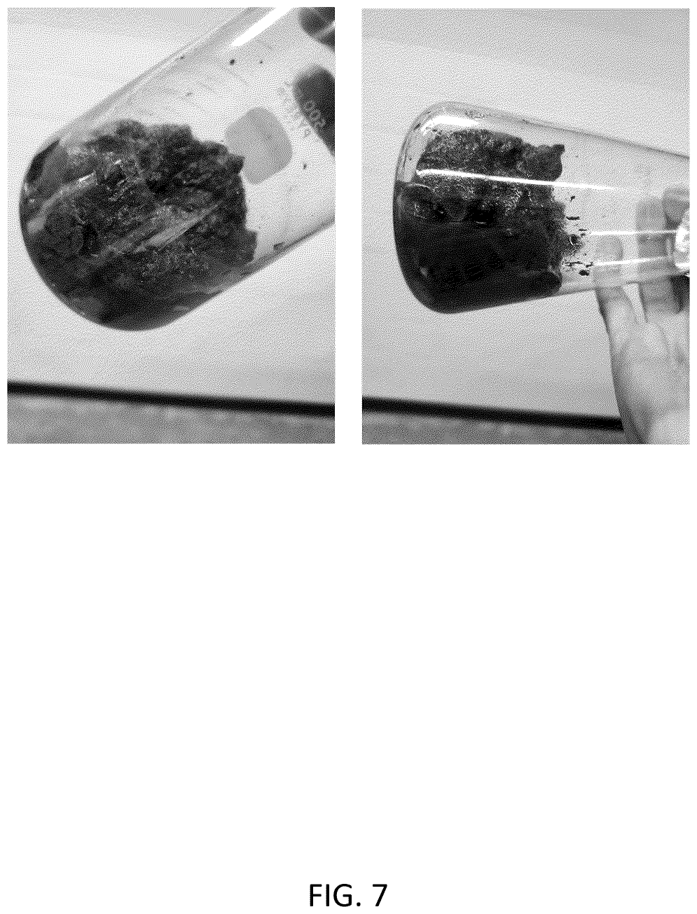

The biomass produced as a result of the cPAM and xanthan gum formulation was dewatered using various methods, or not at all. The biomass was surprisingly stable with an almost putty-like consistency. An unexpected result was that the biomass exhibited syneresis when at rest and naturally shed water to about 7-10% solids before any post processing (FIG. 7). After post processing, the material reached greater than 18% solids with minimal manual effort. (Table 6).

Biomass samples were separated from 15,000 gal tanks of algae laden water treated with cPAM and xanthan after DAF. Each day, approximately 10-15 gal of biomass was collected and analyzed for percent dry content (solids %). A Mettler-Toledo HC103 halogen moisture analyzer was used to determine solids content of a five-gram sample of biomass. The biomass was then transferred to a mesh screen and manually pressed to further remove water. Biomass was also taken to a mechanical screw press to investigate high shear but continuous throughput dewatering of the material. It was determined that the biomass could resist non-shear compression stress but shear stress from the screw press caused the material to lose cohesion rapidly.

TABLE 6

| | | | Algae | Sample | Solids |
|---|---|---|---|---|---|
| Treatment | Day | Method | Processing | Replicate | (%) |
| T1 | 1 | Mettler- | None | 1 | 7.06 |
| | | Toledo | | | |
| T1 | 2 | Mettler- | None | 1 | 9.51 |
| | | Toledo | | | |
| T1 | 2 | 110° C. | None | 2 | 9.17 |
| | | Oven | | | |
| T1 | 3 | Mettler- | None | 1 | 10.71 |
| | | Toledo | | | |
| T1 | 3 | Mettler- | Manual | 2 | 19 |
| | | Toledo | Dewatering | | |
| T1 | 4 | Mettler- | None | 1 | 6.79 |
| | | Toledo | | | |
| T1 | 4 | Mettler- | Manual | 2 | 18.01 |
| | | Toledo | Dewatering | | |
| T1 | 5 | Mettler- | None | 1 | 7.74 |
| | | Toledo | | | |
| T1 | 5 | Mettler- | Screw Press | 2 | 10.12 |
| | | Toledo | | | |
| T1 | 5 | Mettler- | Screw Press | 3 | 9.99 |
| | | Toledo | | | |
| T1 | 5 | Mettler- | Screw Press | 4 | 8.72 |
| | | Toledo | | | |
| T1 | 6 | Mettler- | None | 1 | 6.51 |
| | | Toledo | | | |
| T1 | 7 | Mettler- | None | 1 | 6.96 |
| | | Toledo | | | |
| T1 | 7 | Mettler- | Gravity Drain | 1 | 9.67 |
| | | Toledo | | | |

Toxicity analysis. The treatment of natural waters requires ecological toxicity considerations to avoid further damage to the ecosystem and food chain. Testing chemicals for aquatic toxicity can be an expensive and time-consuming process. Traditionally, any cationic material (e.g., cPAM) tends to be toxic to small fish due to an interaction between the charged particles and the respiration process through the gills. As such, many industrial suppliers decline to provide or even measure aquatic toxicity of their products despite marketing them as eco-friendly for water treatment.

Toxicity analysis can be performed as set forth in OECD/OCDE 202, Guideline for Testing of Chemicals. This guideline describes an acute toxicity test to assess effects of chemicals towards daphnids (Ceriodaphnia dubia). In general, young daphnids, aged less than 24 hours at the start of the test, are exposed to the test substance at a range of concentrations for a period of 48 hours. Immobilization is recorded and compared with control values. The percentage immobilized are plotted against test concentration, and the data are analyzed by appropriate statistical methods (e.g., probit analysis, etc.) to calculate the slopes of the curves and the LC₅₀ with 95% confidence limits (p=95).

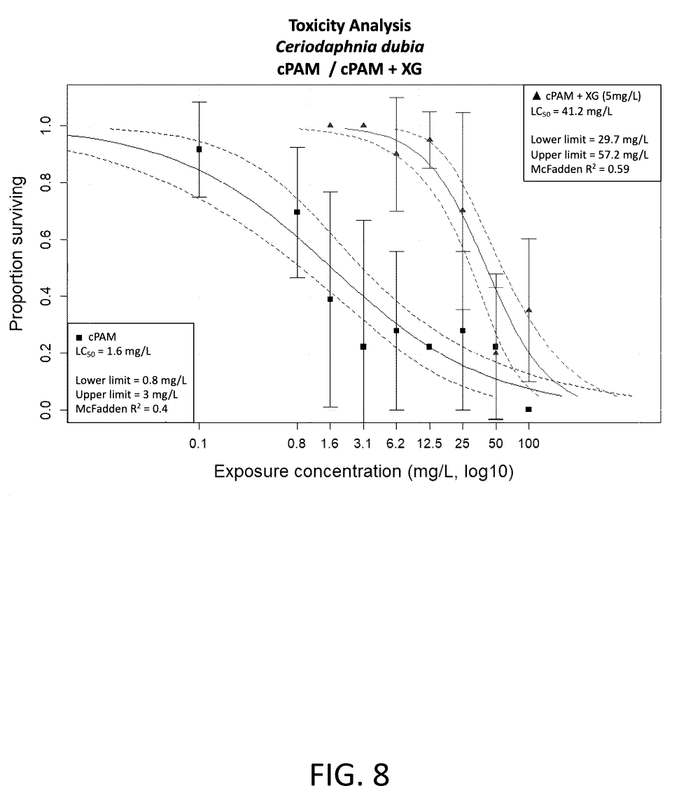

Toxicity analysis of the effects of cPAM (TRAMFLOC®) and the combination of cPAM and XG were performed on C. dubia, according to OECD/OCDE 202. The GLM fit (generalized linear model) was calculated, along with 95% confidence intervals (CIs). The results are shown in FIG. 8.

The LC₅₀ of cPAM when used alone was calculated to be 1.6 mg/L. The LC₅₀ of the combination of cPAM+XG (5 mg/L) was calculated to be 41.2 mg/L. The combination of cPAM+XG had about 25-fold less toxicity than cPAM alone. A water treatment system with a combination of cPAM and xanthan gum as flocculation agents reduced the toxicity of cPAM.

Throughout the present disclosure, the words “comprise”, “include”, “contain, and “having” and variations such as “comprises”, “comprising”, “includes”, “including” and “containing” are to be interpreted inclusively. That is, these words are intended to convey the possible inclusion of other elements or integers not specifically recited, where the context allows.

The articles “a” and “an” are used herein to refer to one or to more than one of the grammatical object of the article. By way of example, “an element” may mean one element or more than one element. If the specification or claims refer to “an additional” element, that does not preclude there being more than one of the additional element.

It is to be understood that where reference is made herein to a method or process that includes two or more defined steps, the defined steps can be carried out in any order or simultaneously (except where context excludes that possibility), and the process can also include one or more other steps which are carried out before any of the defined steps, between two of the defined steps, or after all of the defined steps (except where context excludes that possibility). Methods of the disclosure may be implemented by performing or completing manually, automatically, or a combination thereof, selected steps or tasks.

For purposes of the disclosure, the term “at least” followed by a number is used herein to denote the start of a range beginning with that number (which may be a range having an upper limit or no upper limit, depending on the variable being defined). For example, “at least 1” means 1 or more than 1. Terms of approximation, such as “about,” should be interpreted according to their ordinary and customary meanings as used in the associated art unless indicated otherwise. Absent a specific definition and absent ordinary and customary usage in the associated art, such terms should be interpreted to be ±10% of the base value.

When a range is given as “(a first number) to (a second number)” or “(a first number)−(a second number)” this means a range whose lower limit is the first number and whose upper limit is the second number. For example, 25 to 100 or 25-100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

In view of the many possible embodiments to which the principles of the present disclosure may be applied, it should be recognized that the illustrated embodiments are only examples of the present disclosure and should not be taken as limiting the scope of the disclosure. Rather the scope of the present disclosure is defined in part by the following claims.

What is claimed is:

1. A water treatment system, comprising:
a first composition comprising cationic polyacrylamide (cPAM); and
a second composition comprising xanthan.

2. The water treatment system of claim 1, wherein the first composition and the second composition are provided in the form of a kit.

3. The water treatment system of claim 1, further comprising microorganisms flocculated from an aqueous media.

4. The water treatment system of claim 3, wherein the microorganisms are cyanobacteria, algae, or a combination thereof.

5. The water treatment system of claim 3, wherein the cPAM, xanthan, and microorganisms combine to form a biomass having a solids content of at least 7% or greater by weight.

6. A method for removing microorganisms from aqueous media, comprising:
adding a composition comprising cPAM and a composition comprising xanthan to an aqueous media comprising the microorganisms, in respective amounts sufficient to form cohesive stable thread-like flocs in the aqueous media;
forming the thread-like flocs, the flocs comprising the cPAM, the xanthan, and the microorganisms entrapped therein; and
separating the thread-like flocs from the aqueous media, thereby removing the microorganisms from the aqueous media.

7. The method of claim 6, wherein the aqueous media is freshwater, saltwater, or brackish water.

8. The method of claim 6, further comprising forming a biomass from the separated thread-like flocs and dewatering the biomass to a solids content of at least 7% or greater by weight.

9. The method of claim 6, further comprising forming a biomass from the separated thread-like flocs and processing the biomass to a solids content of at least 16% or greater by weight.

10. The method claim 6, wherein the thread-like flocs are formed on the surface of the aqueous media.

11. The method of claim 10, wherein the flocs are separated from the aqueous media by skimming the surface of the aqueous media or by withdrawing the flocs from the surface of the aqueous media by an angled rotating conveyer belt that lifts the flocs out of the aqueous media.

12. The method of claim 6, comprising flowing the aqueous media through a screen, mesh, or porous filter to separate the thread-like flocs from the aqueous media.

13. A method of flocculating microorganisms in an aqueous media, comprising contacting the microorganisms with cPAM, contacting the microorganisms with xanthan, and flocculating the microorganisms.

14. The method of claim 13, wherein the microorganisms comprise cyanobacteria, algae, or a combination thereof.

15. The method of claim 13, wherein the xanthan is present in the aqueous media in an amount sufficient to bind the microorganisms together, and the cPAM is present in the aqueous media in an amount sufficient to complex with the xanthan and microorganisms to form cohesive stable thread-like flocs.

16. The method of claim 13, wherein the cPAM, xanthan, and microorganisms form cohesive stable thread-like flocs in the aqueous media.

17. The method of claim 13, wherein the concentration of cPAM in the aqueous media is in a range of about 0.01 ppm to about 1000 ppm, by weight.

18. The method of claim 13, wherein the concentration of xanthan in the aqueous media is in a range of about 0.01 ppm to about 1000 ppm, by weight.

19. The method of claim 13, comprising first contacting the microorganisms with the xanthan to infuse the microorganisms and bind the microorganisms together, and then contacting the xanthan infused and bound microorganisms with the cPAM.

20. A method for treating a harmful algal bloom (HAB) in an aqueous media, comprising adding to the aqueous media the water treatment system of claim 1.

21. The method of claim 20, further comprising:
forming stable thread-like flocs, the flocs comprising cPAM, xanthan, and HAB microorganisms entrapped therein; and
separating the thread-like flocs from the aqueous media, thereby removing the HAB microorganisms from the aqueous media.

22. The method of claim 20, wherein the HAB comprises cyanobacteria.
